(19) United States
(12) Patent Application Publication
(10) Pub. No.: US 2010/0109184 A1
(43) Pub. Date: May 6, 2010

(54) METHOD FOR THE MANUFACTURE OF AN ENGINE SHAFT

(75) Inventors: Karl SCHREIBER, Am Mellensee (DE); Raimund GROTHAUS, Dresden (DE)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: ROLLS-ROYCE DEUTSCHLAND LTD & CO KG, Blankenfelde-Mahlow (DE)

(21) Appl. No.: 12/613,194

(22) Filed: Nov. 5, 2009

(30) Foreign Application Priority Data
Nov. 5, 2008 (DE) 10 2008 056 017.0

(51) Int. Cl. B29C 33/76; B29C 43/00

(52) U.S. Cl. 264/101; 264/319

(57) ABSTRACT

For the manufacture of a tubular low-pressure turbine shaft made of a fiber-composite material with metallic driven/driving protrusions (2) attached to its ends, the fiber material is wound onto a winding core (4) provided in the form of a closed tube and made of high-strength material and onto a conically tapered adapter (3) formed on the driven/driving protrusion. By expanding the winding core with a pressurized liquid medium, the fiber material embedded in a synthetic resin is compacted as a function of the design of the winding body and the liquid pressure. Upon curing of the synthetic resin at elevated temperature the winding core is pressure-relieved and removed with reduced diameter.

This application claims priority to German Patent Application DE 10 2008 056 017.0 filed Nov. 5, 2008, the entirety of which is incorporated by reference herein.

This invention relates to a method for the manufacture of an engine shaft, in particular the low-pressure turbine shaft or the radial shaft for a gas-turbine engine.

The low-pressure turbine shaft, which is arranged concentrically in the hollow intermediate-pressure turbine shaft—or in the high-pressure turbine shaft on a two-spool engine—and is provided at its ends with coupling elements (for load input and load output) for connection to the fan and the low-pressure turbine has smaller diameter, greater length, lower speed and higher loading than the other two shafts. Accordingly, the low-pressure turbine shaft is a highly loaded, critical engine component which, on the one hand, shall not fail under any circumstances and, on the other hand, shall have smallest possible outer diameter to permit the use of rotor disks with small inner diameter to provide lightweight and powerful engines. The low-pressure turbine shaft, which is usually made of steel or a nickel-base material and is forged and hollowed out, is expensive to manufacture and also heavy. To enable the low-pressure turbine shaft to transmit higher torques and attain greater length, higher speed and high stiffness with smallest possible shaft outer diameter, an inward increase of the wall thickness is the only way. However, this will cause the natural frequency of the low-pressure shaft to fall and approach the natural frequency of the engine, with the consequence that, besides a higher weight, the risk of damaging the low-pressure turbine shaft is increased.

These requirements apply similarly to the radial shaft connecting an internal and an external gear drive, with the radial shaft being driven at both ends, although always in the same direction. As a consequence, different torques are applied to the radial shaft. Like the low-pressure shaft, the radial shaft must be designed as slender as possible.

In a broad aspect the present invention provides for a method for the manufacture of an engine shaft which enables high torques to be transmitted while featuring maximum possible length, small diameter and reduced weight.

The present invention, in its essence, provides for the manufacture of the low-pressure turbine shaft or the radial shaft for gas-turbine engines from a tubular formed fiber-composite material and a metallic driven protrusion for load output and, if applicable, a driving protrusion for load input connected to the fiber-composite material, in that a fiber material and a high-temperature resistant synthetic resin are applied to a winding core provided in the form of a closed, pressure-proof tube and to a conically tapered adapter of the driven protrusion and, if applicable, the driving protrusion which frontally adjoins the winding core, in that the fiber material is compacted by expanding the winding core with a liquid pressure medium introduced into the latter and in that the synthetic resin is cured in this state at elevated temperature. Upon curing the synthetic resin and relieving the pressure from the winding core leading to a reduction in the diameter thereof, the winding core can be removed. The proposed method enables engine shafts with small diameter and great length to be provided which, owing to the high and circumferentially uniform fiber compaction which is controllable via the internal pressure of the winding core, are capable of transmitting very high torques while being lightweight.

In development of the present invention, the fiber material is wound in the dry state and the synthetic resin infiltrated under vacuum into the fiber material upon enveloping the latter with a tubular external tool.

According to yet another feature of the present invention, the fiber material is wound together with the synthetic resin in a wet winding process. In this process, in which the tubular external tool is dispensable, the fiber material is still strongly compacted.

In a further development of the present invention, the material and the wall thickness of the winding core as well as the pressure applied by the liquid pressure medium in the interior of the winding core are matched to each other such that the outer diameter of the winding core is widened to a certain size and the fiber material compacted by a certain amount.

The present invention is more fully described in light of the accompanying drawings showing a preferred embodiment. In the drawings,

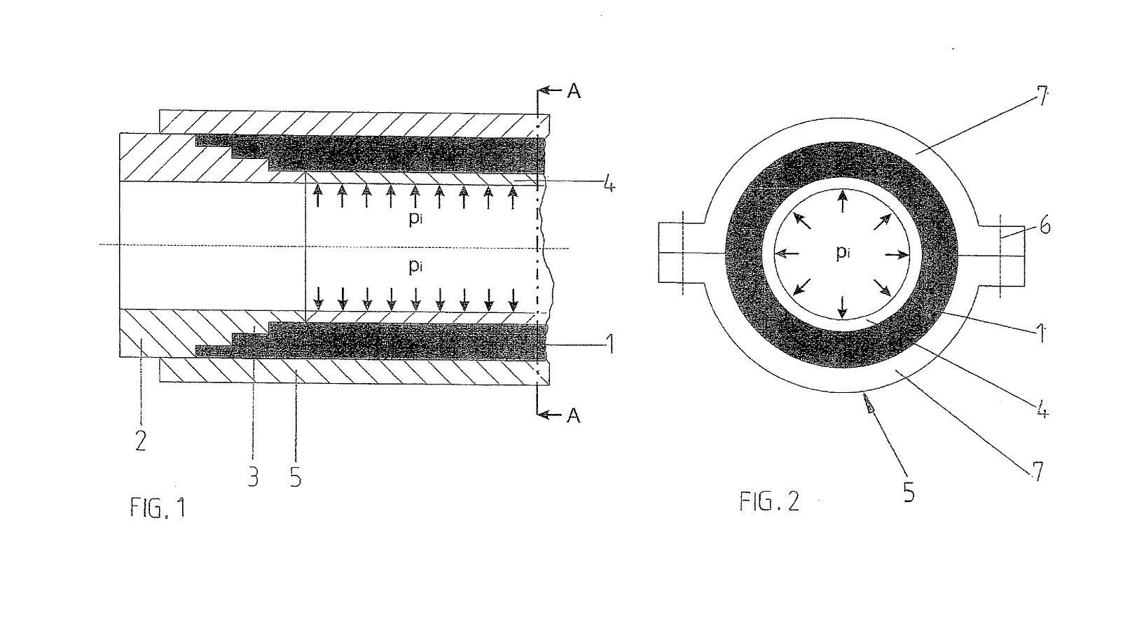

FIG. 1 is a sectional view of the load-transferring end of a low-pressure turbine shaft made of fiber-composite material during the manufacturing process, and

FIG. 2 is a sectional view along the line A-A in FIG. 1.

The low-pressure turbine shaft includes a hollow body 1 made of fiber-composite material, i.e. carbon-fibers embedded in a high-pressure resistant plastic matrix, whose outer diameter in the present variant shall be limited to 100 mm. A steel-made driven protrusion 2 for load output is incorporated into the end of the low-pressure turbine shaft facing the fan, actually such that an adapter 3 with—here stepwise—decreasing diameter formed on the driven protrusion 2 is wound with the fiber material (here carbon fibers) and tied to the latter. The opposite end of the low-pressure turbine shaft, which is connected to the low-pressure turbine of an engine, can, for load input, be connected in the same way to a driving protrusion or be provided with a flange (not shown) formed from the fiber-composite material.

The low-pressure turbine shaft described hereinbefore is manufactured in that the front-side end of the adapter 3 (or the two adapters of the driven and the driving protrusion, if applicable) is operatively connected to a closed, tubular winding core 4 connectable to a compressed-air source and subsequently the fibers—here carbon fibers—are wound onto the winding core 4 and the adapter 3 of the driven protrusion 2 (and, if applicable, the driving protrusion, not shown) in a specific orientation differing in individual fiber layers so that, on the one hand, transmission of high torsional forces is ensured and, on the other hand, high stiffness and natural frequency of the low-pressure turbine shaft are provided for.

Subsequently, a tubular external tool 5 which here includes two half shells 7 connected by bolts 6 is placed around the wound-on fiber material. Subsequently, a high-temperature resistant synthetic resin is infiltrated at increased pressure (6 bars) into the fiber material, actually at a vacuum produced therein, via ports provided in the external tool 5. In the following step, the fibers are compacted by an internal pressure p, produced in the winding core 4 made of high-strength heat-treatment steel by introduction of a liquid pressure medium and an expanding of the winding core resulting therefrom. The internal pressure as well as the material and the wall thickness of the winding core are matched to each other such that the fiber material between the outer surface of the winding core 4 and the inner surface of the external tool 5 is compacted as required. Upon curing the resin infiltrated with vacuum support into the fiber-material winding at elevated temperature, with the liquid pressure medium not further expanding and the winding core not being further widened in the process, and subsequent lowering of the internal pressure pᵢ, the external tool 5 and the winding core 4 are removed.

The fibers can also be wound onto the not yet widened winding core 4 in a wet winding process dispensing with the external tool. Subsequently, the winding core 4—as described hereinbefore—is expanded by use of a liquid pressure medium, with the fiber material being compacted in the process. Upon curing the high-temperature resistant resin, which in this variant is introduced already during the winding process, the winding core 4 is relieved and then removed.

### LIST OF REFERENCE NUMERALS

1 Tubular hollow body, fiber-composite material
2 Driven protrusion
3 Adapter
4 Closed, tubular winding core
5 Tubular external tool
6 Bolts
7 Half shells

What is claimed is:

1. A method for the manufacture of an engine shaft, comprising:
applying a fiber material oriented in certain winding layers and a high-temperature resistant synthetic resin embedding the fiber material to a winding core made of high-strength material and provided in the form of a closed tube and also to a conically tapered adapter of a metallic driven protrusion, with the adapter frontally adjoining the winding core;
introducing a pressurized liquid medium into an interior of the winding core to expand the winding core and thereby compact the fiber material;
subsequently curing the synthetic resin at elevated temperature;
removing the pressurized liquid medium from the winding core to reduce an outer diameter of the winding core; and
removing the winding core.

2. The method of claim 1, and further comprising:
winding the fiber material in a dry state;
enveloping the fiber material with an external tubular tool; and
infiltrating the synthetic resin under vacuum into the fiber material.

3. The method of claim 2, wherein the external tubular tool includes two half shells which can be clamped together.

4. The method of claim 1, and further comprising winding the fiber material together with the synthetic resin in a wet winding process.

5. The method of claim 1, wherein the winding core is made of a high-strength heat-treatment steel.

6. The method of claim 1, and further comprising: matching the material and the wall thickness of the winding core as well as the pressure applied by the pressurized liquid medium in the interior of the winding core to each other such that the outer diameter of the winding core is expanded to a certain size and the fiber material is compacted by a certain amount.

7. The method of claim 1, and further comprising winding the fiber material on a metallic driving protrusion.
